(19) United States
(12) Patent Application Publication
(10) Pub. No.: US 2018/0119923 A1
(43) Pub. Date: May 3, 2018

(54) PHOSPHOR SUBSTRATE, LIGHT SOURCE DEVICE, AND PROJECTION DISPLAY UNIT

(71) Applicant: SONY CORPORATION, TOKYO (JP)

(72) Inventors: MASAHIRO TAKADA, TOKYO (JP); YUKI MAEDA, KANAGAWA (JP)

(21) Appl. No.: 15/569,293

(22) PCT Filed: Apr. 19, 2016
(86) PCT No.: PCT/JP2016/062347

§ 371 Date: Oct. 25, 2017

(30) Foreign Application Priority Data
May 14, 2015 (JP) 2015-099209

(51) Int. Cl. F21V 9/30; G03B 21/20; F21V 29/10; F21V 29/502; G02B 26/00

(52) U.S. Cl. CPC F21V 9/30; G03B 21/204; G02B 26/008; F21V 29/502; F21V 29/10

(57) ABSTRACT

A phosphor substrate according to an embodiment of the present technology includes a substrate configured to be rotatable, and a phosphor layer disposed at a center of the substrate. This allows a displacement amount of the phosphor layer to be smaller than a situation when an annular phosphor layer is disposed on an outer edge of the substrate in a case where warpage occurs in the substrate due to stress caused by respective thermal expansions of the phosphor layer and the substrate.

### TECHNICAL FIELD

The present technology relates to a phosphor substrate, a light source device, and a projection display unit.

### BACKGROUND ART

As a light source for use in a projection display unit such as a projector, a solid-state light source having long life and having a wide color gamut has attracted attentions. In recent years, a light source device has been put into use in units such as the projector. The light source device utilizes light emitted from a phosphor through irradiation of the phosphor with light of the solid-state light source.

The above-described light source device includes, for example, a phosphor layer, and a solid-state light source that irradiates the phosphor layer with excitation light. Light emission of the phosphor layer involves a phenomenon of luminance saturation or temperature quenching. This is a phenomenon in which, in a case where an output of the excitation light is made higher, a portion of conversion loss in the phosphor layer is turned into heat to cause the phosphor layer to generate heat, thus lowering a fluorescence conversion efficiency. When the fluorescence conversion efficiency is in a low state, it is not possible to achieve a bright light source device with a favorable efficiency. Therefore, the phosphor layer is provided on a surface of a substrate having high thermal conductivity.

### CITATION LIST

### Patent Literature

PTL 1: Japanese Unexamined Patent Application Publication No. 2013-130605

### SUMMARY OF INVENTION

Incidentally, a phosphor layer and a substrate on which the phosphor layer is provided are fixed together with an adhesive layer being interposed therebetween in some cases, or are directly fixed together by a method such as normal temperature bonding and optical contact in some cases. Accordingly, warpage occurs in the substrate due to stress caused by respective thermal expansions of the phosphor layer and the substrate, thus causing deviation of a focal position. As a result, there may be an issue of deteriorated fluorescence conversion efficiency. Such an issue may occur even in the invention of PTL 1 in which a thin film is provided on a surface of a ceramic phosphor in order to allow a temperature distribution of the ceramic phosphor to be uniform.

It is therefore desirable to provide a phosphor substrate, a light source device, and a projection display unit that make it possible to reduce deviation of a focal point caused by thermal expansions.

A phosphor substrate according to a first embodiment of the present technology includes a substrate configured to be rotatable, and a phosphor layer disposed at a center of the substrate.

A light source device according to a first embodiment of the present technology includes a substrate configured to be rotatable, a phosphor layer disposed at a center of the substrate, and a light source that irradiates the phosphor layer with excitation light.

A projection display unit according to a first embodiment of the present technology includes a substrate configured to be rotatable, a phosphor layer disposed at a center of the substrate, and a light source that irradiates the phosphor layer with excitation light. The projection display unit further includes a light modulating section that generates image light by modulating the excitation light emitted from the light source on a basis of an image signal, and a projecting section that projects the image light generated in the light modulating section.

In the phosphor substrate, the light source device, and the projection display unit according to the first embodiment of the present technology, the phosphor layer is disposed at the center of the substrate. This enables a displacement amount of the phosphor layer to be smaller than a situation when the phosphor layer is disposed on the outer edge of the substrate or on the entire substrate in a case where warpage occurs in the substrate due to stress caused by the respective thermal expansions of the phosphor layer and the substrate.

A phosphor substrate according to a second embodiment of the present technology includes a substrate, and a phosphor layer disposed at a center of the substrate. The phosphor layer includes a phosphor and a binder that holds the phosphor. The substrate and the binder are each made of a same type of material.

A light source device according to a second embodiment of the present technology includes a substrate, a phosphor layer disposed at a center of the substrate, and a light source that irradiates the phosphor layer with excitation light. The phosphor layer includes a phosphor and a binder that holds the phosphor. The substrate and the binder are each made of a same type of material.

A projection display unit according to a second embodiment of the present technology includes a substrate, a phosphor layer disposed at a center of the substrate, and a light source that irradiates the phosphor layer with excitation light. The projection display unit further includes a light modulating section that generates image light by modulating the excitation light emitted from the light source on a basis of an image signal, and a projecting section that projects the image light generated in the light modulating section. The phosphor layer includes a phosphor and a binder that holds the phosphor. The substrate and the binder are each made of a same type of material.

In the phosphor substrate, the light source device, and the projection display unit according to the second embodiment of the present technology, the phosphor layer is disposed at the center of the substrate. This enables a displacement amount of the phosphor layer to be smaller than a situation when the phosphor layer is disposed on the outer edge of the substrate or on the entire substrate in a case where warpage occurs in the substrate due to stress caused by the respective thermal expansions of the phosphor layer and the substrate. Further, in the present technology, the substrate and the binder are each made of the same type of material. This enables the displacement amount of the phosphor layer to be smaller than a situation when the substrate and the binder are made of different types of materials in the case where warpage occurs in the substrate due to stress caused by the respective thermal expansions of the phosphor layer and the substrate.

A phosphor substrate according to a third embodiment of the present technology includes a substrate, and a phosphor layer disposed at a center of the substrate. The substrate and the phosphor layer are made of respective materials that allow the substrate and the phosphor layer to have a difference in linear expansion coefficients of 1×10⁻⁶ cm/° C. or smaller.

A light source device according to a third embodiment of the present technology includes a substrate, a phosphor layer disposed at a center of the substrate, and a light source that irradiates the phosphor layer with excitation light. The substrate and the phosphor layer are made of respective materials that allow the substrate and the phosphor layer to have a difference in linear expansion coefficients of 1×10⁻⁶ cm/° C. or smaller.

A projection display unit according to a third embodiment of the present technology includes a substrate, a phosphor layer disposed at a center of the substrate, and a light source that irradiates the phosphor layer with excitation light. The projection display unit further includes a light modulating section that generates image light by modulating the excitation light emitted from the light source on a basis of an image signal, and a projecting section that projects the image light generated in the light modulating section. The substrate and the phosphor layer are made of respective materials that allow the substrate and the phosphor layer to have a difference in linear expansion coefficients of 1×10⁻⁶ cm/° C. or smaller.

In the phosphor substrate, the light source device, and the projection display unit according to the third embodiment of the present technology, the phosphor layer is disposed at the center of the substrate. This enables a displacement amount of the phosphor layer to be smaller than a situation when the phosphor layer is disposed on the outer edge of the substrate or on the entire substrate in a case where warpage occurs in the substrate due to stress caused by the respective thermal expansions of the phosphor layer and the substrate. Further, in the present technology, the substrate and the phosphor layer are made of respective materials that allow the substrate and the phosphor layer to have a difference in linear expansion coefficients of 1×10⁻⁶ cm/° C. or smaller. This enables the displacement amount of the phosphor layer to be smaller than a case where the substrate and the phosphor layer are made of respective materials that allow the substrate and the phosphor layer to have a difference exceeding 1×10⁻⁶ cm/° C. in linear expansion coefficients.

According to the phosphor substrate, the light source device, and the projection display unit of the first embodiment of the present technology, it becomes possible to decrease the amount of the displacement of the phosphor layer that occurs due to the stress caused by the thermal expansions, thus allowing for reduction in the deviation of the focal position caused by the thermal expansions. It is to be noted that the effects of the present technology is not necessarily limited to those described here, and may include any of effects that are described herein.

According to the phosphor substrate, the light source device, and the projection display unit of the second embodiment of the present technology, it becomes possible to decrease the amount of the displacement of the phosphor layer that occurs due to the stress caused by the thermal expansions, thus allowing for reduction in the deviation of the focal position caused by the thermal expansions. It is to be noted that the effects of the present technology is not necessarily limited to those described here, and may include any of effects that are described herein.

According to the phosphor substrate, the light source device, and the projection display unit of the third embodiment of the present technology, it becomes possible to decrease the amount of the displacement of the phosphor layer that occurs due to the stress caused by the thermal expansions, thus allowing for reduction in the deviation of the focal position caused by the thermal expansions. It is to be noted that the effects of the present technology is not necessarily limited to those described here, and may include any of effects that are described herein.

### BRIEF DESCRIPTION OF DRAWINGS

FIG. 1 illustrates a cross-sectional configuration example and a planar configuration example of a phosphor substrate according to a first embodiment of the present technology.

FIG. 2 illustrates a modification example of the cross-sectional configuration of the phosphor substrate of FIG. 1.

FIG. 3A illustrates a modification example of the cross-sectional configuration of the phosphor substrate of FIG. 1.

FIG. 3B illustrates a modification example of the cross-sectional configuration of the phosphor substrate of FIG. 1.

FIG. 4 illustrates a modification example of the cross-sectional configuration of the phosphor substrate of FIG. 1.

FIG. 5A illustrates a modification example of the cross-sectional configuration of the phosphor substrate of FIG. 1.

FIG. 5B illustrates a modification example of the cross-sectional configuration of the phosphor substrate of FIG. 1.

FIG. 5C illustrates a modification example of the cross-sectional configuration of the phosphor substrate of FIG. 1.

FIG. 6 illustrates a modification example of each of the cross-sectional configuration and the planar configuration of the phosphor substrate of FIG. 1.

FIG. 7 illustrates a cross-sectional configuration example of the phosphor substrate of FIG. 1, with a shaft of a motor being attached thereto via an attachment.

FIG. 8 illustrates a schematic configuration example of a light source device using any of the phosphor substrates illustrated in FIGS. 1 to 7.

FIG. 9 describes an example of irradiation of the phosphor substrate with excitation light, in the light source device of FIG. 8.

FIG. 10 describes an example of the irradiation of the phosphor substrate with the excitation light, in the light source device of FIG. 8.

FIG. 11 describes an example of irradiation of the phosphor substrate with excitation light, in the light source device of FIG. 8.

FIG. 12 describes an example of the irradiation of the phosphor substrate with the excitation light, in the light source device of FIG. 8.

FIG. 13 illustrates a cross-sectional configuration example and a planar configuration example of a phosphor substrate according to a second embodiment of the present technology.

FIG. 14 illustrates a modification example of the cross-sectional configuration of the phosphor substrate of FIG. 13.

FIG. 15A illustrates a modification example of the cross-sectional configuration of the phosphor substrate of FIG. 13.

FIG. 15B illustrates a modification example of the cross-sectional configuration of the phosphor substrate of FIG. 13.

FIG. 16 illustrates a modification example of the cross-sectional configuration of the phosphor substrate of FIG. 13.

FIG. 17 illustrates a cross-sectional configuration example of the phosphor substrate of FIG. 13, with a base section being attached thereto.

FIG. 18 illustrates a schematic configuration example of a light source device using any of the phosphor substrates illustrated in FIGS. 13 to 17.

FIG. 19 describes an example of irradiation of the phosphor substrate with excitation light, in the light source device of FIG. 18.

FIG. 20 describes an example of the irradiation of the phosphor substrate with the excitation light, in the light source device of FIG. 18.

FIG. 21 illustrates a schematic configuration example of a projection display unit according to a third embodiment of the present technology.

### MODES FOR CARRYING OUT THE INVENTION

In the following, some embodiments of the invention are described in detail with reference to drawings. The following description is a specific example of the invention, and the invention is not limited to the following embodiments. Moreover, the invention is not limited to positions, dimensions, dimension ratios, and other factors of respective components illustrated in the drawings. It is to be noted that description is given in the following order.

1. First Embodiment (Phosphor Substrate and Light Source Device)

2. Second Embodiment (Phosphor Substrate and Light Source Device)

3. Third Embodiment (Projection Display Unit)

### 1. First Embodiment

### [Configuration]

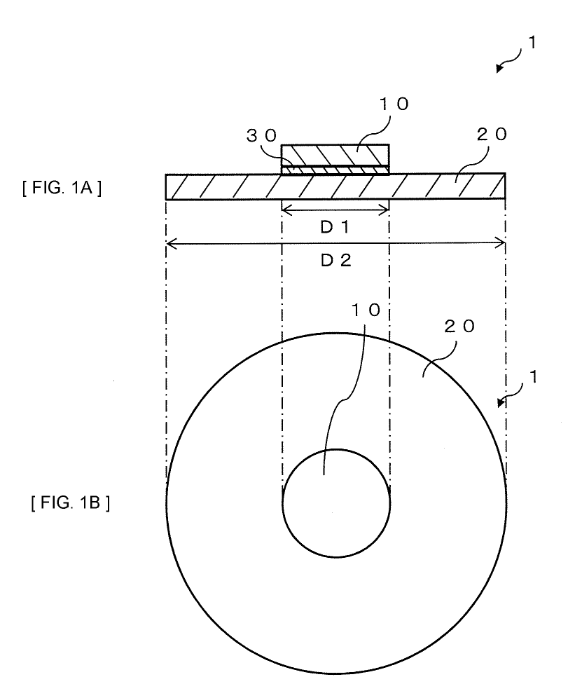

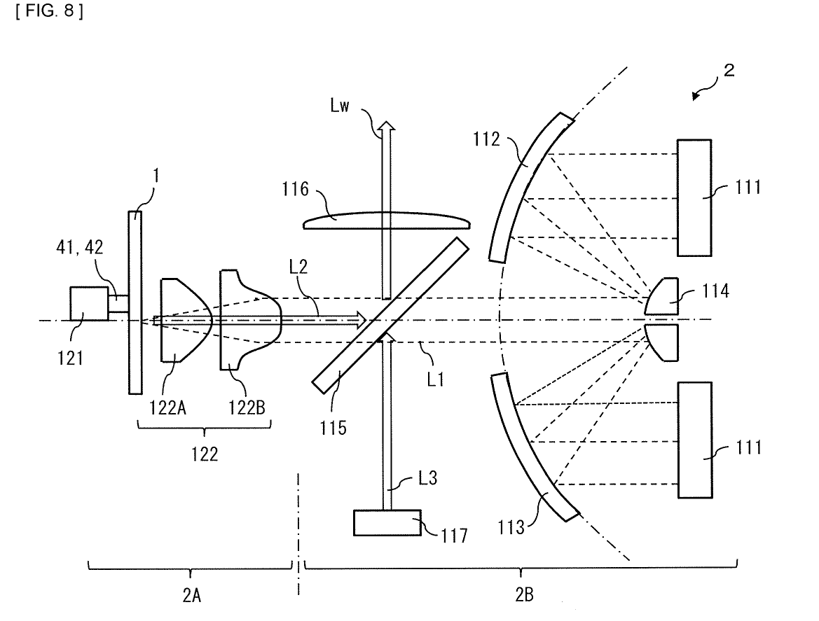

Description is given of a configuration of a phosphor substrate 1 according to a first embodiment of the present technology. The phosphor substrate 1 corresponds to a specific example of a “phosphor substrate” of the present technology. FIG. 1 illustrates a cross-sectional configuration example and a planar configuration example of the phosphor substrate 1 according to the first embodiment of the present technology. The phosphor substrate 1 is applicable, for example, to a light converting section 2A of a light source device 2 described later (refer to FIG. 8). The phosphor substrate 1 includes a substrate 20 and a phosphor layer 10.

The substrate 20 is configured to be rotatable, and is rotationally symmetric, for example. The substrate 20 is shaped to be rotationally symmetric around a rotational axis AX1 of a shaft 41 described later, for example, when being attached to the shaft 41 via an attachment 42 described later. As illustrated in (B) of FIG. 1, for example, the substrate 20 has a disc shape. The substrate 20 is made of a material having high thermal conductivity. For example, the substrate 20 is made of a material such as a metal-based or alloy-based material, a ceramic-based material, a ceramic-metal-mixed material, crystals such as sapphire, diamond, and glass. Here, examples of the metal-based or alloy-based material include Al, Cu, Mo, W, and CuW. Examples of the ceramic-based material include SiC, AlN, Al₂O₃, Si₃N₄, ZrO₂, and Y₂O₃. Examples of the ceramic-metal-mixed material include SiC—Al, SiC—Mg, and SiC—Si.

The substrate 20 has a diameter D2 ranging, for example, from 20 mm to 100 mm. The substrate 20 has a thickness ranging, for example, from 0.3 mm to 2.0 mm. The substrate 20 may be configured by a single layer, or a plurality of layers. In a case where the substrate 20 is configured by a single layer, the substrate 20 is preferably made of a material with high reflectance. In a case where the substrate 20 is configured by a plurality of layers, a layer constituting a top surface of the substrate 20 is preferably made of the material with high reflectance.

The phosphor layer 10 is disposed at the center of the substrate 20. As illustrated in (B) of FIG. 1, for example, the phosphor layer 10 has a disc shape, and is disposed concentrically with the substrate 10. Upon incidence of light of a specific wavelength, the phosphor layer 10 is excited by the light (incident light) of the specific wavelength to emit light of a wavelength different from the wavelength of the incident light. The phosphor layer 10 contains, for example, a fluorescent substance that is excited by blue light having a center wavelength of about 445 nm to emit yellow fluorescence (yellow light). When blue light is incident, for example, the phosphor layer 10 converts a portion of the blue light into yellow light. The fluorescent substance contained in the phosphor layer 10 is, for example, a YAG-based phosphor (e.g., Y₃Al₅O₁₂). The YAG-based phosphor is one of fluorescent substances each excited by the blue light having the center wavelength of about 445 nm to emit the yellow fluorescence (yellow light). In a case where the fluorescent substance contained in the phosphor layer 10 is the YAG-based phosphor, the YAG-based phosphor may be doped with Ce.

The phosphor layer 10 may contain an oxide phosphor other than the YAG-based phosphor. The phosphor layer 10 may contain a phosphor other than the oxide phosphor. For example, the phosphor layer 10 may contain an oxynitride phosphor, a nitride-based phosphor, a sulfide phosphor, or a silicate-based phosphor. Here, the oxynitride phosphor is, for example, a BSON phosphor (e.g., Ba₃Si₆O₁₂N₂:Eu²⁺). The nitride-based phosphor is, for example, a CASN phosphor (e.g., CaAlSiN₃:Eu) or a SiAlON phosphor. The sulfide phosphor is, for example, a SGS phosphor (e.g., SrGa₂S₄:Eu). The silicate-based phosphor is, for example, a TEOS phosphor (e.g., Si(OC₂H₅)₄).

The phosphor layer 10 contains, for example, a powdered phosphor and a binder that holds the powdered phosphor. The phosphor layer 10 may be, for example, a phosphor layer in which the powdered phosphor and the powdered phosphor are solidified by an inorganic material. The phosphor layer 10 may be formed, for example, by applying, onto the substrate 20, a substance containing the powdered phosphor and the binder that holds the powdered phosphor. The phosphor layer 10 may be formed, for example, by sintering a substance containing the powdered phosphor and the binder (e.g., ceramic material) that holds the powdered phosphor. It is to be noted that the powered phosphor contained in the phosphor layer 10 is, for example, any of the above-described various phosphors. The phosphor layer 10 may be a polycrystalline plate made of a phosphor material. The polycrystalline plate is formed by processing a polycrystalline material made of the phosphor material into a plate shape.

The substrate 20 and the phosphor layer 10 are preferably made of respective materials that allow the substrate 20 and the phosphor layer 10 to have a difference in linear expansion coefficients of 1×10⁻⁶ cm/° C. or smaller per meter. In a case where the phosphor layer 10 is a polycrystalline plate made of the YAG-based phosphor doped with Ce, the phosphor layer 10 has a linear expansion coefficient of about 8.0×10⁻⁶ m/° C. per meter. In a case where the substrate 20 is made of a titanium alloy, the substrate 20 has a linear expansion coefficient of about 8.4×10⁻⁶ m/° C. per meter. Accordingly, in a case where the phosphor layer 10 is the polycrystalline plate made of the YAG-based phosphor doped with Ce and the substrate 20 is made of the titanium alloy, the substrate 20 and the phosphor layer 10 have a difference of 0.4×10⁻⁶ cm/° C. per meter in linear expansion coefficients. In other words, in a case where the phosphor layer 10 is the polycrystalline plate made of the ceramic material and the substrate 20 is made of the titanium alloy, the substrate 20 and the phosphor layer 10 have a difference in linear expansion coefficients of 1×10⁻⁶ cm/° C. or smaller per meter.

In a case where the substrate 20 is made of a material having a large linear expansion coefficient, such as aluminum (23×10⁻⁶ cm/° C. per meter), stainless steel (17×10⁻⁶ cm/° C. per meter), and copper (17×10⁻⁶ cm/° C. per meter), the substrate 20 and the phosphor layer 10 have a difference that is a value much larger than 1×10⁻⁶ cm/° C. per meter in linear expansion coefficients.

For example, suppose that the phosphor layer 10 is made of a ceramic material, and that the substrate 20 is made of aluminum. In addition, for example, suppose that the phosphor layer 10 has a diameter of 20 and that a temperature of the phosphor layer 10 is set at 200° C., whereas a temperature of the substrate 20 is set at 150° C., with a room temperature being set at 20° C. In this case, respective expansion amounts are as follows.

| | |
|---|---|
| Phosphor Layer 10: | 14.4 μm |
| Substrate 20: | 29.9 μm |

Thus, a difference in the expansion amounts is approximately 15.5 μm.

In contrast, for example, suppose that the phosphor layer 10 is made of a ceramic material, and that the substrate 20 is made of a titanium alloy. In addition, for example, suppose that the phosphor layer 10 has a diameter of 20 and that a temperature of the phosphor layer 10 is set at 200° C., whereas a temperature of the substrate 20 is set at 150° C., with a room temperature being set at 20° C. In this case, respective expansion amounts are as follows.

| | |
|---|---|
| Phosphor Layer 10: | 14.4 μm |
| Substrate 20: | 10.9 μm |

Thus, a difference in the expansion amounts is approximately 3.5 as small as one fifth of the above-described expansion amounts.

The substrate 20 and the binder contained in the phosphor layer 10 are each preferably made of the same type of material, and may each contain the ceramic material, for example. In this case, the substrate 20 and the phosphor layer 10 necessarily have a difference in linear expansion coefficients of 1×10⁻⁶ cm/° C. or smaller.

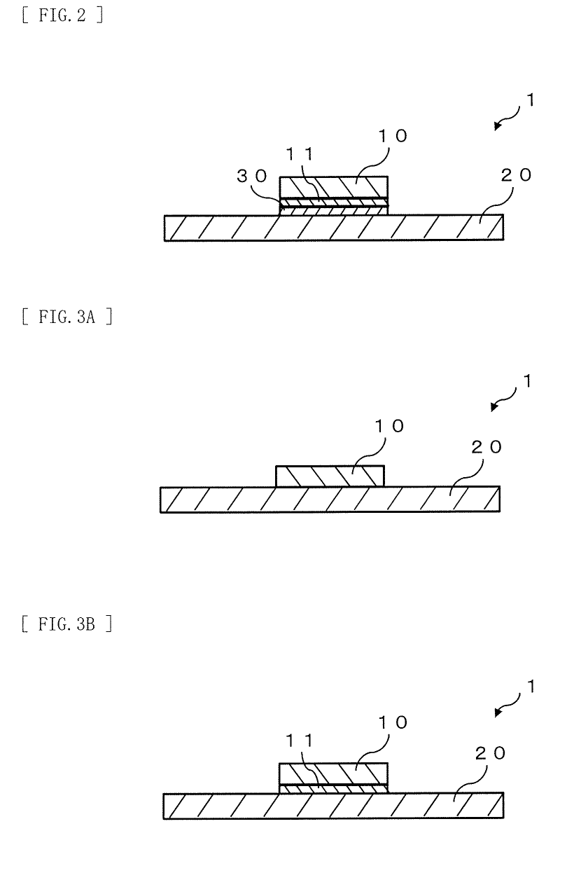

The phosphor layer 10 has a diameter D1 ranging, for example, from 3 mm to 60 mm. When the substrate 20 has the diameter D2 of 20 mm, the phosphor layer 10 has the diameter D1 of 3 mm, for example. When the substrate 20 has the diameter D2 of 100 mm, the phosphor layer 10 has the diameter D1 of 60 mm, for example. The phosphor layer 10 may be configured by a single layer, or a plurality of layers. In a case where the phosphor layer 10 is configured by a plurality of layers, a layer constituting a surface (undersurface), of the phosphor layer 10, on side of the substrate 20 may contain a material with high reflectance. Further, as illustrated in FIG. 2, for example, the phosphor substrate 1 may include, between the phosphor layer 10 and the substrate 20, a reflective layer 11 that contains the material with high reflectance. In a case where the substrate 20 and the binder contained in the phosphor layer 10 each contain the ceramic material, the reflective layer 11 may contain a powdered metal material with high reflectance and the ceramic material as the binder.

Furthermore, as illustrated in FIGS. 1 and 2, for example, the phosphor substrate 1 may include, between the substrate 20 and the phosphor layer 10, a fixing layer 30 that fixes the substrate 20 and the phosphor layer 10 together. The fixing layer 30 is made of, for example, a material such as an organic material and an inorganic material. Examples of the organic material to be used as the fixing layer 30 include an acrylic resin, an epoxy resin, a silicone resin, and a fluorine resin. Examples of the inorganic material to be used as the fixing layer 30 include solder, fritted glass, silicate glass, a silica adhesive, an alumina adhesive, and a ceramic-based adhesive.

It is to be noted that, as illustrated in FIG. 3A, for example, the fixing layer 30 may be omitted in the phosphor substrate 1. In this case, the phosphor layer 10 is fixed directly to the substrate 20, without fixing layer 30 being interposed therebetween. In this case, the substrate 20 and the binder contained in the phosphor layer 10 may each contain the ceramic material. At this time, the substrate 20 and the phosphor layer 10 may be each formed, for example, by sintering the plurality of layers each containing the ceramic material in a state of being joined together.

Further, as illustrated in FIG. 3B, for example, the fixing layer 30 may be omitted in the phosphor substrate 1. In this case, the phosphor layer 10 is fixed to the substrate 20 with the reflective layer 11, instead of the fixing layer 30, being interposed therebetween. In this case, the substrate 20 and the binder contained in the phosphor layer 10 may each contain the ceramic material, whereas the reflective layer 11 may contain the powdered metal material with high reflectance and the ceramic material as the binder. At this time, the substrate 20, the reflective layer 11, and the phosphor layer 10 may be each formed, for example, by sintering the plurality of layers each containing the ceramic material in a state of being joined together.

In a case where the fixing layer 30 is omitted in the phosphor substrate 1, the substrate 20 and the phosphor layer 10 may be bonded together by means of, for example, normal temperature bonding or optical contact. Further, in the case where the fixing layer 30 is omitted in the phosphor substrate 1, the substrate 20 and the reflective layer 11 may be bonded together by means of, for example, the normal temperature bonding or the optical contact. Furthermore, in the case where the fixing layer 30 is omitted in the phosphor substrate 1, the phosphor layer 10 and the reflective layer 11 may be bonded together by means of, for example, the normal temperature bonding or the optical contact.

The normal temperature bonding includes surface activated bonding and atom diffusion bonding. The surface activated bonding refers to surface-treating a bonded surface of substances in vacuum and performing activation to thereby bond two substances without application of an adhesive, heat, or pressure. For example, argon sputtering is used to remove oxides or impurities present on the bonded surface of the substances, thus activating the bonded surface of the substances. The atomic diffusion bonding refers to forming a microcrystalline film on a bonded surface of substances in ultra-high vacuum and superimposing the two thin films in vacuum to thereby bond the two substances at normal temperature without application of pressure or voltage. The optical contact refers to a bonding method that brings precisely polished flat surfaces into close contact with each other to thereby cause molecules on the flat surfaces to undergo mutual interaction, thus stabilizing the molecules on the flat surfaces as with inner molecules.

As illustrated in FIG. 4, for example, the phosphor substrate 1 may further include a heat releasing section 50 made of a material with relatively high thermal conductivity on a rear surface (surface, of the substrate 20, on side opposite to the phosphor layer 10) of the substrate 20. The heat releasing section 50 is configured by, for example, a plurality of fins extending in a predetermined direction. The fins are each made of, for example, light-weight metal with relatively high thermal conductivity such as aluminum.

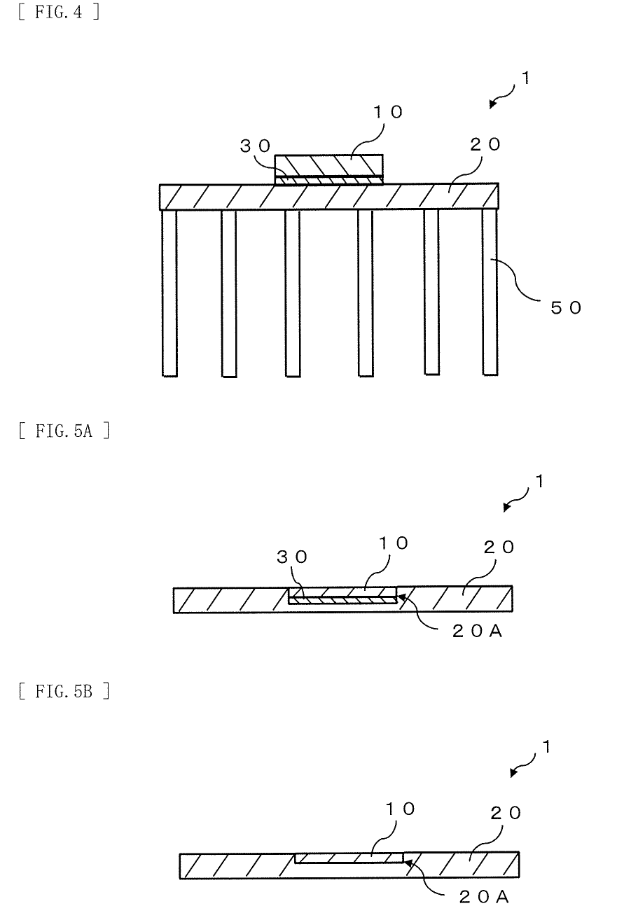

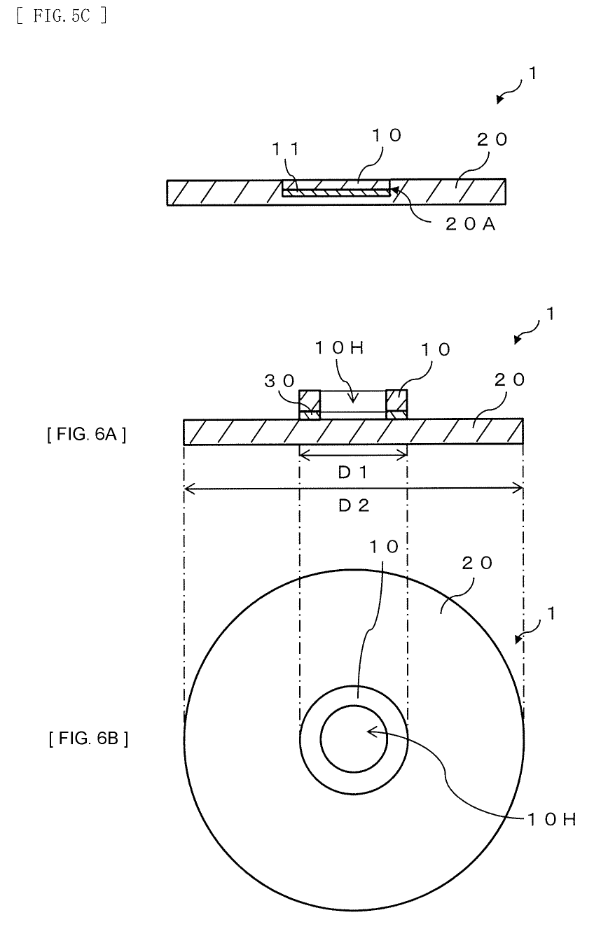

As illustrated in FIGS. 5A, 5B, and 5C, for example, the substrate 20 may have a recessed part 20A at the center of the substrate 20 in the phosphor substrate 1. The recessed part 20A has a diameter (inner diameter) that is equal to or larger than the diameter D1 of the phosphor layer 10, and the phosphor layer 10 is disposed inside the recessed part 20A. In the substrate 20, a part corresponding to a bottom part of the recessed part 20A may be thinned by a thickness in which the recessed part 20A is formed. In the substrate 20, the part corresponding to the bottom part of the recessed part 20A may have a thickness equivalent to that of a part in which the recessed part 20A is not formed.

As illustrated in FIG. 5A, for example, the phosphor layer 10 may be fixed onto a bottom surface of the recessed part 20A with the fixing layer 30 being interposed therebetween. As illustrated in FIG. 5B, for example, the phosphor layer 10 may be directly fixed onto the bottom surface of the recessed part 20A without the fixing layer 30 being interposed therebetween. As illustrated in FIG. 5C, for example, the phosphor layer 10 may be fixed onto the bottom surface of the recessed part 20A with the reflective layer 11 being interposed therebetween. The inner surface of the recessed part 20A and the phosphor layer 10 preferably have refractive indexes that are different from each other. In this case, the inner surface of the recessed part 20A serves as a reflection surface that reflects light emitted from the phosphor layer 10. A top surface of the phosphor layer 10 may be disposed in the same plane with the top surface of the substrate 20, or in a plane different from the top surface of the substrate 20.

In the case where the phosphor layer 10 is directly fixed onto the bottom surface of the recessed part 20A without the fixing layer 30 being interposed therebetween in the phosphor substrate 1, the substrate 20 and the binder contained in the phosphor layer 10 may contain the ceramic material. In this case, the substrate 20 and the phosphor layer 10 may be each formed, for example, by sintering the plurality of layers each containing the ceramic material in a state of being joined together.

Further, in the case where the phosphor layer 10 is fixed onto the bottom surface of the recessed part 20A with the reflective layer 11 being interposed therebetween in the phosphor substrate 1, the substrate 20 and the binder contained in the phosphor layer 10 may contain the ceramic material, whereas the reflective layer 11 may contain the powdered metal material with high reflectance and the ceramic material as the binder. At this time, the substrate 20, the reflective layer 11, and the phosphor layer 10 may be each formed, for example, by sintering the plurality of layers each containing the ceramic material in a state of being joined together.

It is to be noted that, as illustrated in FIG. 6, for example, the phosphor layer 10 may have a ring shape having an opening 10H at the center of the phosphor layer 10. In this case, the phosphor layer 10 has a diameter (outer diameter) that is equal to the above-described D1. The phosphor layer 10 has an inner diameter (diameter of the opening 10H) that is smaller than an inner diameter of an irradiated region (light-irradiated region 10B described later; refer to FIG. 10) irradiated by excitation light that irradiates the phosphor layer 10.

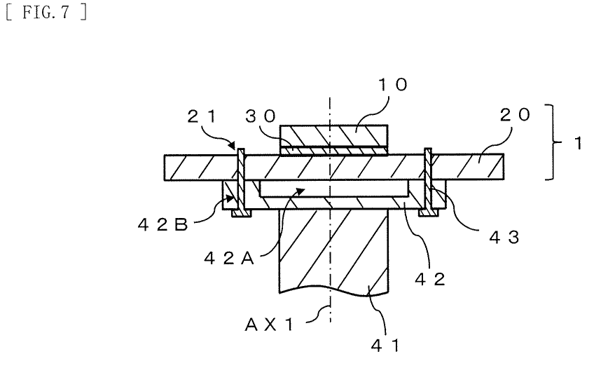

FIG. 7 illustrates a cross-sectional configuration example of each of the phosphor substrate 1, the attachment 42, and the shaft 41, with the shaft 41 of a motor being attached to the phosphor substrate 1 via the attachment 42. It is to be noted that FIG. 7 exemplifies a state where the shaft 41 of the motor is attached to the phosphor substrate 1 illustrated in FIG. 1 via the attachment 42.

The attachment 42 serves to couple the phosphor substrate 1 and a tip of the shaft 41 of the motor to each other. The attachment 42 is configured to be rotatable, and is rotationally symmetric, for example. The attachment 42 is shaped to be rotationally symmetric around the rotational axis AX1 of the shaft 41, for example, when being attached to the shaft 41. The attachment 42 is so fixed to the substrate 20 as to avoid a part, of the substrate 20, immediately below the phosphor layer 10. The attachment 42 has a disc shape, for example, and has a recessed part 42A at the center of the disc as well as a plurality of openings 42B, on the outer edge of the disc, through which respective screws 43 are inserted. The substrate 20 has openings 21 at locations corresponding to the respective openings 42B when the attachment 42 is attached to the substrate 20. The insertion of the screws 43 into the respective openings 42B and the respective openings 21 allows the attachment 42 to be fixed to the substrate 20.

### [Light Source Device 2]

Description is given next of a light source device 2 including the above-described phosphor substrate 1. FIG. 8 illustrates a schematic configuration example of the light source device 2 using the above-described phosphor substrate 1. The light source device 2 is a light source device in which the above-described phosphor substrate 1 is applied to the light converting section 2A. Specifically, the light source device 2 includes the light converting section 2A and a light source section 2B.

The light source section 2B serves to irradiate the light converting section 2A with excitation light L1. The light source section 2B corresponds to a specific example of a “light source” of the present technology. The light source section 2B includes, for example, two light sources 111, condensing mirrors 112, 113, and 114, and a dichroic mirror 115. Each of the light sources 111 emits light (excitation light L1) having a peak wavelength of emission intensity within a wavelength range suitable for excitation of the phosphor layer 10. Suppose that the phosphor layer 10 contains a fluorescent substance that is excited by light (blue light) having a wavelength within a wavelength range from 400 nm to 500 nm to emit yellow fluorescence. In this case, each of the light sources 111 includes one of a semiconductor laser and a light-emitting diode that each emit, as the excitation light L1, the blue light having a peak wavelength of emission intensity within the wavelength range from 400 nm to 500 nm.

Each of the condensing mirror 112 and 113 is a concave reflecting mirror, for example, and reflects light (excitation light L1) emitted from corresponding one of two light sources 111 toward the condensing mirror 114, and condenses the emitted light. The condensing mirror 114 is a convex reflecting mirror, for example, and causes pieces of light reflected by the respective condensing mirrors 112 and 113 to be pieces of light that are substantially parallel and reflects them toward the phosphor layer 10.

The dichroic mirror 115 selectively reflects color light of a predetermined wavelength, and transmit light of other wavelengths. The dichroic mirror 115 transmits pieces of light (excitation light L1) emitted from the two light sources 111, and reflects light (fluorescence L2) emitted from the phosphor layer 10. The dichroic mirror 115 also transmits light L3 emitted from a light source 117 described later. Here, a direction in which the fluorescence L2 travels after having been reflected by the dichromic mirror 115 and a direction in which the light L3 travels are equal to each other. Thus, the dichroic mirror 115 mixes the fluorescence L2 and the light L3 together, and emits the mixed light in a predetermined direction. The light L3 is light having a peak wavelength of emission intensity within a wavelength range common to that of the excitation light L1. In a case where the excitation light L1 is the blue light having a peak wavelength of emission intensity within the wavelength range from 400 nm to 500 nm, the light L3 is also the blue light having a peak wavelength of emission intensity within the wavelength range from 400 nm to 500 nm.

The light source section 2B also serves to generate the light L3 that allows for generation of white light Lw by mixing the light L3 with the light (fluorescence L2) outputted from the light converting section 2A. The light source section 2B further includes a single light source 117 and a condensing lens 116, for example. The light source 117 emits the light L3. The light source 117 includes one of a semiconductor laser and a light-emitting diode that each emit the light L3. The light condensing lens 116 condenses the mixed light (white light Lw) generated in the dichroic mirror 115, and outputs the condensed mixed light toward any other optical system.

The light converting section 2A serves to output, to the light source section 2B, the fluorescence L2 having a peak of emission intensity within a wavelength range different from the wavelength range of the excitation light L1. The light converting section 2A outputs the fluorescence L2 to the light source section 2B, with the light emitted from the light source section 2B as the excitation light L1. The light converting section 2A includes the phosphor substrate 1, a motor 121 coupled to the phosphor substrate 1 via the attachment 42, and a condensing lens 122 disposed at a position facing the top surface of the phosphor substrate 1 at a predetermined spacing. The condensing lens 122 serves to condense the excitation light L1 inputted from the light source section 2B and to irradiate a predetermined position of the phosphor layer 10. The condensing lens 122 includes a lens 122a and a lens 122b, for example.

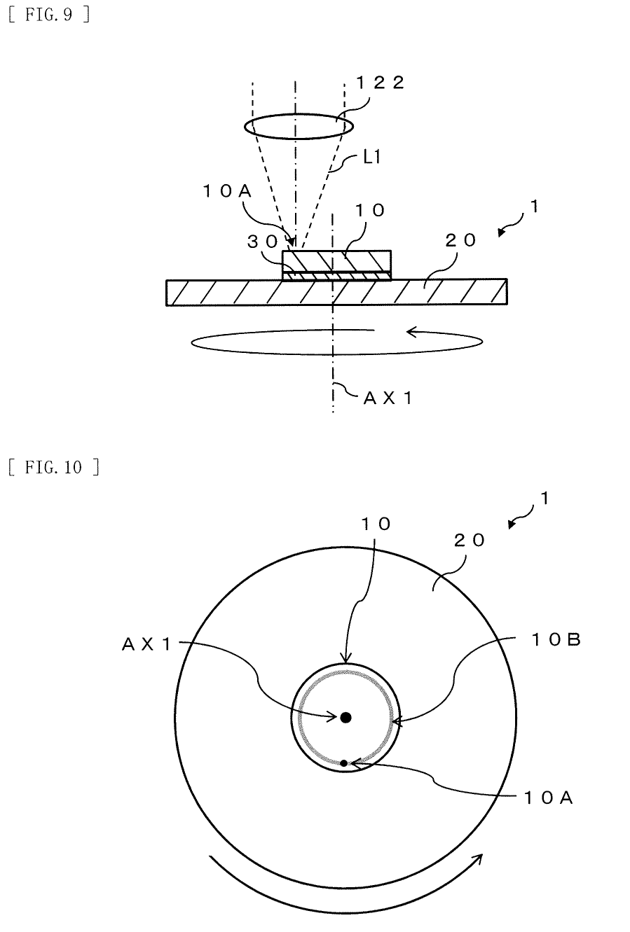

FIGS. 9 and 10 illustrate an example of irradiation of the phosphor substrate 1 with the excitation light L1, in the light source device 2. The light condensing lens 122 is configured to cause the excitation light L1 after having been condensed by the condensing lens 122 to irradiate the outer edge of the top surface of the phosphor layer 10. Here, a part, of the phosphor layer 10, to be irradiated by the excitation light L1 during non-rotation of the phosphor layer 10 is denoted as a light-irradiated point 10A. When the phosphor layer 10 is irradiated by the excitation light L1, the phosphor layer 10 rotates around the rotational axis AX1 together with the substrate 20. Accordingly, the excitation light L1 irradiates the outer edge of the top surface of the phosphor layer 10 annularly during the rotation of the phosphor layer 10. Thus, the light-irradiated point 10A moves along the outer edge of the top surface of the phosphor layer 10 during the rotation of the phosphor layer 10. It is to be noted that the light-irradiated region 10B of FIG. 10 corresponds to an annular region along which the light-irradiated point 10A passes on the top surface of the phosphor layer 10.

Now suppose that an energy distribution of the excitation light L1 is Gaussian distribution. In this case, the excitation light L1 has a beam diameter that corresponds to a diameter of a light flux having an intensity equal to or larger than 1/e² (=13.5%) of center intensity. Here, suppose that the light-irradiated point 10A has a diameter that is equal to the beam diameter of the excitation light L1. At this time, the light-irradiated region 10B has a line width that is equal to the diameter of the light-irradiated point 10A, and thus the line width of the light-irradiated region 10B is equal to the beam diameter of the excitation light L1.

Here, 99.9% or more of the total energy of the excitation light L1 is within a light flux with a diameter that is 1.52 times as large as the beam diameter of the excitation light L1. Therefore, the condensing lens 122 is preferably disposed to allow the top surface of the phosphor layer 10 to be irradiated by the light flux with a diameter that is 1.52 times as large as the beam diameter of the excitation light L1 (the diameter of the light-irradiated point 10A). Suppose that the beam diameter of the excitation light L1 (the diameter of the light-irradiated point 10A) is 3 mm from the viewpoint of a light conversion efficiency. At this time, the condensing lens 122 is preferably disposed to allow the center of the light-irradiated point 10A to be positioned 2.28 mm (=3 mm×1.52/2) or more distant from an end edge of the top surface of the phosphor layer 10.

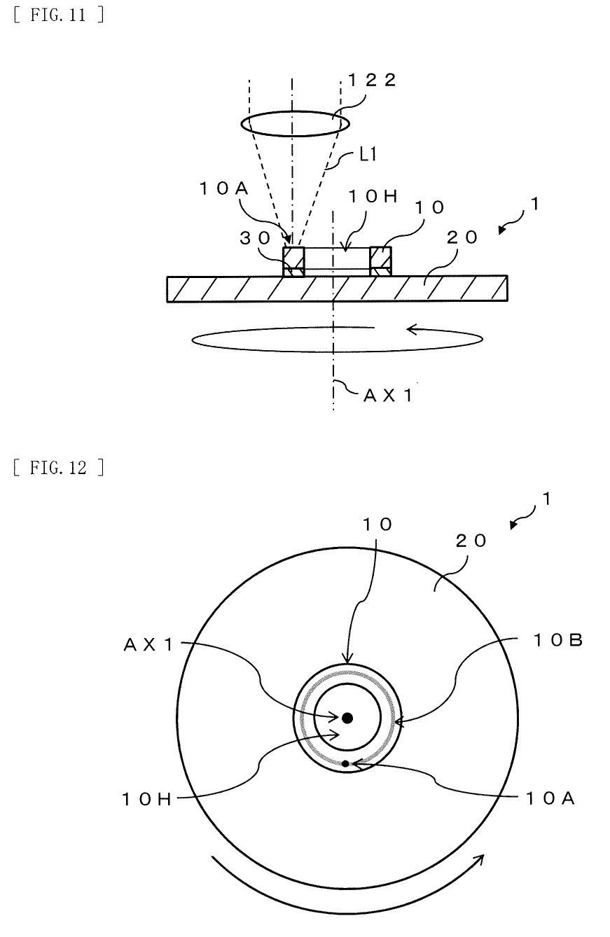

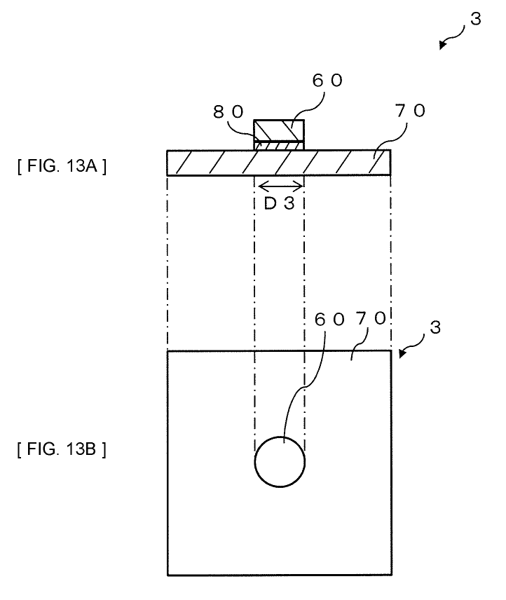

It is to be noted that the condensing lens 122 may be disposed to allow the center of the light-irradiated point 10A to be positioned 2.28 mm (=3 mm×1.52/2) distant from the end edge of the top surface of the phosphor layer 10. At this time, it follows that the light flux with a diameter that is 1.52 times as large as the beam diameter of the excitation light L1 (the diameter of the light-irradiated point 10A) irradiates a belt-shaped region between the end edge of the top surface of the phosphor layer 10 and a position that is 4.56 mm (=2.28 mm×2) distant from the end edge of the top surface of the phosphor layer 10. Accordingly, in this case, it follows that a part, of the phosphor layer 10, that is more distant than 4.56 mm from the end edge of the top surface of the phosphor layer 10 does not contribute to generation of excitation light L2. Thus, the phosphor layer 10 may be configured by only a part that contributes to the generation of the excitation light L2. For example, as illustrated in FIGS. 11 and 12, the phosphor layer 10 may have an annular shape having the opening 10H. At this time, the phosphor layer 10 has a line width that is larger than the diameter that is 1.52 times as large as the beam diameter of the excitation light L1 (the diameter of the light-irradiated point 10A). In a case where the beam diameter of the excitation light L1 (the diameter of the light-irradiated point 10A) is 3 mm from the viewpoint of the light conversion efficiency, the line width of the phosphor layer 10 is larger than 4.56 mm.

### [Effects]

Description is given next of effects of the phosphor substrate 1 and the light source device 2 according to the present embodiment.

Light emission of the phosphor layer typically involves a phenomenon of luminance saturation or temperature quenching. This is a phenomenon in which, in a case where an output of the excitation light is made higher, a portion of conversion loss in the phosphor layer is turned into heat to cause the phosphor layer to generate heat, thus lowering a fluorescence conversion efficiency. When the fluorescence conversion efficiency is in a low state, it is not possible to achieve a bright light source device with a favorable efficiency. Therefore, the phosphor layer is provided on a surface of a substrate having high thermal conductivity.

Incidentally, a phosphor layer and a substrate on which the phosphor layer is provided are fixed together with an adhesive layer being interposed therebetween in some cases, or are directly fixed together by a method such as normal temperature bonding and optical contact in some cases. Accordingly, warpage occurs in the substrate due to stress caused by respective thermal expansions of the phosphor layer and the substrate, thus causing deviation of a focal position of the excitation light. In such a case, there is a possibility that the fluorescence conversion efficiency may be deteriorated.

In the present embodiment, however, the phosphor layer 10 is disposed at the center of the substrate 20. This enables a displacement amount of the phosphor layer 10 to be smaller than a case where the phosphor layer is disposed on the outer edge of the substrate or on the entire substrate even when warpage occurs in the substrate 20 due to stress caused by the respective thermal expansions of the phosphor layer 10 and the substrate 20. As a result, it is possible to reduce the deviation of the focal position caused by the thermal expansions.

Further, in the present embodiment, in a case where the substrate 20 and the binder contained in the phosphor layer 10 are each made of the same type of material, when warpage occurs in the substrate 20 due to stress caused by the respective thermal expansions of the phosphor layer 10 and the substrate 20, it is possible to allow the displacement amount of the phosphor layer 10 to be smaller than a situation when the substrate and the binder contained in the phosphor layer are made of different types of materials. As a result, it is possible to reduce the deviation of the focal position caused by the thermal expansions. Moreover, it is possible to allow the displacement amount of the phosphor layer 10 to be smaller, thus making it possible to reduce a possibility that the phosphor layer 10 may be damaged even in a case where the phosphor layer 10 is configured to be thin and is likely to be damaged.

Furthermore, in the present embodiment, in a case where the substrate 20 and the phosphor layer 10 are made of respective materials that allow the substrate 20 and the phosphor layer 10 to have a difference in linear expansion coefficients of 1×10⁻⁶ cm/° C. or smaller, it is possible to allow the displacement amount of the phosphor layer 10 to be smaller than a case where the substrate and the phosphor layer are made of respective materials that allow the substrate and the phosphor layer 10 to have a difference exceeding 1×10⁻⁶ cm/° C. in linear expansion coefficients. As a result, it is possible to reduce the deviation of the focal position caused by the thermal expansions. Moreover, it is possible to allow the displacement amount of the phosphor layer 10 to be smaller, thus making it possible to reduce the possibility that the phosphor layer 10 may be damaged even in the case where the phosphor layer 10 is configured to be thin and is likely to be damaged.

Description is given below of other embodiments of the present technology. It is to be noted that components common to those of the phosphor substrate 1 of the foregoing embodiment are denoted by same reference numerals. Further, description of the components common to those of the phosphor substrate 1 of the foregoing embodiment are omitted where appropriate.

### 3. Second Embodiment

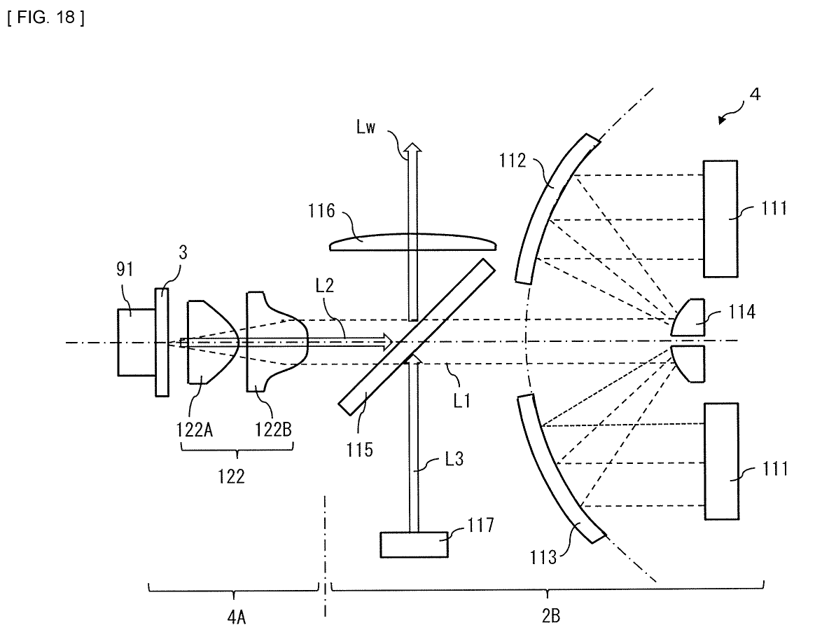

Description is given next of a phosphor substrate 3 according to a second embodiment of the present technology. The phosphor substrate 3 corresponds to a specific example of a “phosphor substrate” of the present technology. FIG. 13 illustrates a cross-sectional configuration example and a planar configuration example of the phosphor substrate 3 according to the second embodiment of the present technology. The phosphor substrate 3 is applicable, for example, to a light converting section 4A of a light source device 4 described later (refer to FIG. 18). The phosphor substrate 3 includes a substrate 70 and a phosphor layer 60.

As illustrated in (B) of FIG. 13, for example, the substrate 70 has a square shape. The substrate 70 may have a shape other than the square shape, such as a disc shape, an elliptical shape, and a polygonal shape. The substrate 70 is made of a material having high thermal conductivity. For example, the substrate 70 is made of a material such as a metal-based or alloy-based material, a ceramic-based material, a ceramic-metal-mixed material, crystals such as sapphire, diamond, and glass. Here, examples of the metal-based or alloy-based material include Al, Cu, Mo, W, and CuW. Examples of the ceramic-based material include SiC, AlN, Al₂O₃, Si₃N₄, ZrO₂, and Y₂O₃. Examples of the ceramic-metal-mixed material include SiC—Al, SiC—Mg, and SiC—Si.

The substrate 70 may be configured by a single layer, or a plurality of layers. In a case where the substrate 70 is configured by a single layer, the substrate 70 is preferably made of a material with high reflectance. In a case where the substrate 70 is configured by a plurality of layers, a layer constituting a top surface of the substrate 70 is preferably made of the material with high reflectance.

The phosphor layer 60 is disposed at the center of the substrate 70. As illustrated in (B) of FIG. 13, for example, the phosphor layer 60 has a disc shape. It is to be noted that the phosphor layer 60 may have a shape other than the disc shape, such as an elliptical shape, a square shape, and a polygonal shape. Upon incidence of light of a specific wavelength, the phosphor layer 60 is excited by the light (incident light) of the specific wavelength to emit light of a wavelength different from the wavelength of the incident light. The phosphor layer 60 contains, for example, a fluorescent substance that is excited by blue light having a center wavelength of about 445 nm to emit yellow fluorescence (yellow light). When blue light is incident, for example, the phosphor layer 60 converts a portion of the blue light into yellow light. The fluorescent substance contained in the phosphor layer 60 is, for example, a YAG-based phosphor (e.g., Y₃Al₅O₁₂). The YAG-based phosphor is one of fluorescent substances each excited by the blue light having the center wavelength of about 445 nm to emit the yellow fluorescence (yellow light). In a case where the fluorescent substance contained in the phosphor layer 60 is the YAG-based phosphor, the YAG-based phosphor may be doped with Ce.

The phosphor layer 60 may contain an oxide phosphor other than the YAG-based phosphor. The phosphor layer 60 may contain a phosphor other than the oxide phosphor. For example, the phosphor layer 60 may contain an oxynitride phosphor, a nitride-based phosphor, a sulfide phosphor, or a silicate-based phosphor. Here, the oxynitride phosphor is, for example, a BSON phosphor (e.g., Ba₃Si₆O₁₂N₂:Eu²⁺). The nitride-based phosphor is, for example, a CASN phosphor (e.g., CaAlSiN₃:Eu) or a SiAlON phosphor. The sulfide phosphor is, for example, a SGS phosphor (e.g., SrGa₂S₄:Eu). The silicate-based phosphor is, for example, a TEOS phosphor (e.g., Si(OC₂H₅)₄).

The phosphor layer 60 contains, for example, a powdered phosphor and a binder that holds the powdered phosphor. The phosphor layer 60 may be, for example, a phosphor layer in which the powdered phosphor and the powdered phosphor are solidified by an inorganic material. The phosphor layer 60 may be formed, for example, by applying, onto the substrate 20, a substance containing the powdered phosphor and the binder that holds the powdered phosphor. The phosphor layer 60 may be formed, for example, by sintering a substance containing the powdered phosphor and the binder (e.g., ceramic material) that holds the powdered phosphor. It is to be noted that the powered phosphor contained in the phosphor layer 60 is, for example, any of the above-described various phosphors. The phosphor layer 60 may be a polycrystalline plate made of a phosphor material. The polycrystalline plate is formed by processing a polycrystalline material made of the phosphor material into a plate shape.

The substrate 70 and the phosphor layer 60 are preferably made of respective materials that allow the substrate 70 and the phosphor layer 60 to have a difference in linear expansion coefficients of 1×10⁻⁶ cm/° C. or smaller per meter. In a case where the phosphor layer 60 is a polycrystalline plate made of the YAG-based phosphor doped with Ce, the phosphor layer 60 has a linear expansion coefficient of about 8.0×10⁻⁶ m/° C. per meter. In a case where the substrate 70 is made of a titanium alloy, the substrate 70 has a linear expansion coefficient of about 8.4×10⁻⁶ m/° C. per meter. Accordingly, in a case where the phosphor layer 60 is the polycrystalline plate made of the YAG-based phosphor doped with Ce and the substrate 70 is made of the titanium alloy, the substrate 70 and the phosphor layer 60 have a difference of 0.4×10⁻⁶ cm/° C. per meter in linear expansion coefficients. In other words, in a case where the phosphor layer 60 is the polycrystalline plate made of the ceramic material and the substrate 70 is made of the titanium alloy, the substrate 70 and the phosphor layer 60 have a difference in linear expansion coefficients of 1×10⁻⁶ cm/° C. or smaller per meter.

The substrate 70 and the binder contained in the phosphor layer 60 are each preferably made of the same type of material, and may each contain the ceramic material, for example. In this case, the substrate 70 and the phosphor layer 60 necessarily have a difference in linear expansion coefficients of 1×10⁻⁶ cm/° C. or smaller.

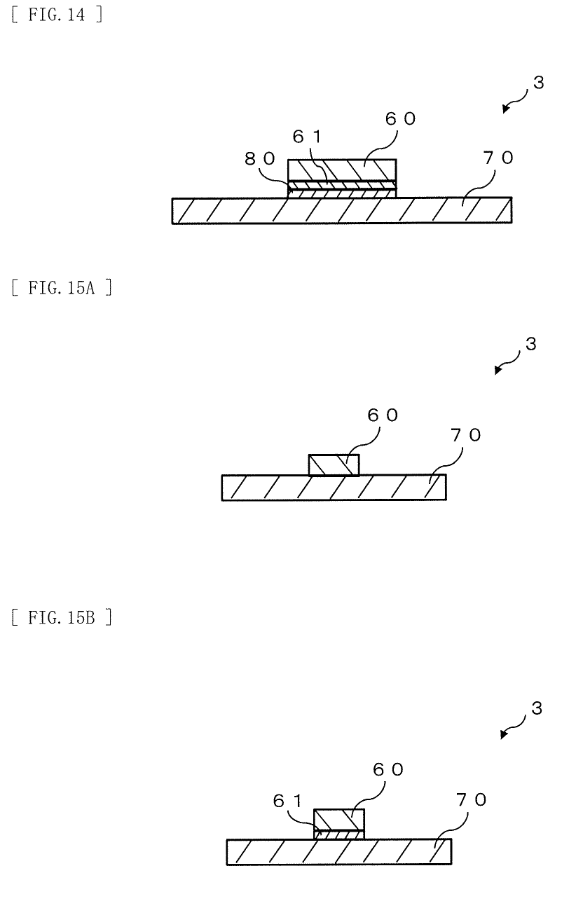

The phosphor layer 60 has a diameter D3 ranging, for example, from 3 mm to 60 mm. The phosphor layer 60 may be configured by a single layer, or a plurality of layers. In a case where the phosphor layer 60 is configured by a plurality of layers, a layer constituting a surface (undersurface), of the phosphor layer 60, on side of the substrate 70 may contain a material with high reflectance. Further, as illustrated in FIG. 14, for example, the phosphor substrate 3 may include, between the phosphor layer 60 and the substrate 70, a reflective layer 61 that contains the material with high reflectance. In a case where the substrate 70 and the binder contained in the phosphor layer 60 each contain the ceramic material, the reflective layer 61 may contain a powdered metal material with high reflectance and the ceramic material as the binder.

Furthermore, as illustrated in FIGS. 13 and 14, for example, the phosphor substrate 3 may include, between the substrate 70 and the phosphor layer 60, a fixing layer 80 that fixes the substrate 70 and the phosphor layer 60 together. The fixing layer 80 is made of, for example, a material such as an organic material and an inorganic material. Examples of the organic material to be used as the fixing layer 80 include an acrylic resin, an epoxy resin, a silicone resin, and a fluorine resin. Examples of the inorganic material to be used as the fixing layer 80 include solder, fritted glass, silicate glass, a silica adhesive, an alumina adhesive, and a ceramic-based adhesive.

It is to be noted that, as illustrated in FIG. 15A, for example, the fixing layer 80 may be omitted in the phosphor substrate 3. In this case, the phosphor layer 60 is fixed directly to the substrate 70, without fixing layer 80 being interposed therebetween. In this case, the substrate 70 and the binder contained in the phosphor layer 60 may each contain the ceramic material. At this time, the substrate 70 and the phosphor layer 60 may be each formed, for example, by sintering the plurality of layers each containing the ceramic material in a state of being joined together.

Further, as illustrated in FIG. 15B, for example, the fixing layer 80 may be omitted in the phosphor substrate 3. In this case, the phosphor layer 60 is fixed to the substrate 70 with the reflective layer 61, instead of the fixing layer 80, being interposed therebetween. In this case, the substrate 70 and the binder contained in the phosphor layer 60 may each contain the ceramic material, whereas the reflective layer 61 may contain the powdered metal material with high reflectance and the ceramic material as the binder. At this time, the substrate 70, the reflective layer 61, and the phosphor layer 60 may be each formed, for example, by sintering the plurality of layers each containing the ceramic material in a state of being joined together.

In a case where the fixing layer 80 is omitted in the phosphor substrate 3, the substrate 70 and the phosphor layer 60 may be bonded together by means of, for example, normal temperature bonding or optical contact. Further, in the case where the fixing layer 80 is omitted in the phosphor substrate 3, the substrate 70 and the reflective layer 61 may be bonded together by means of, for example, the normal temperature bonding or the optical contact. Furthermore, in the case where the fixing layer 80 is omitted in the phosphor substrate 3, the phosphor layer 60 and the reflective layer 61 may be bonded together by means of, for example, the normal temperature bonding or the optical contact.

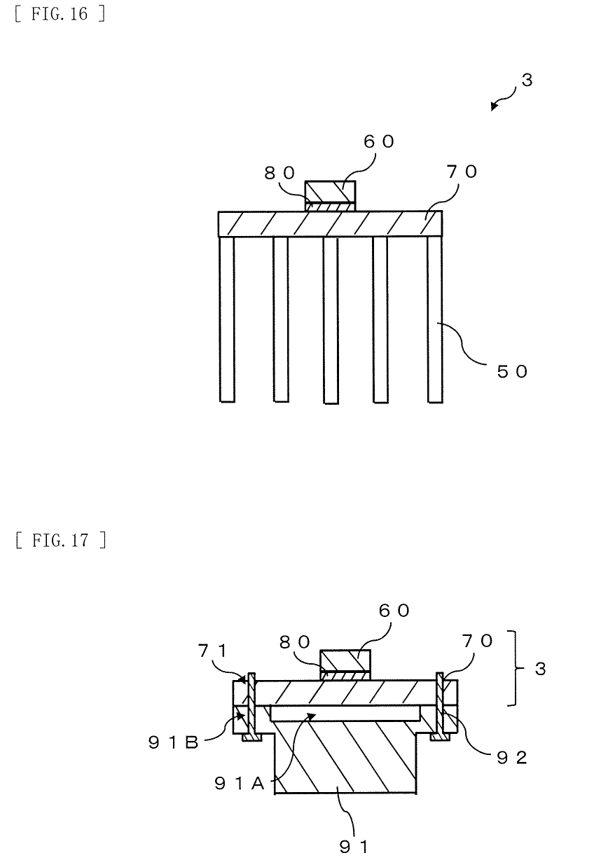

As illustrated in FIG. 16, for example, the phosphor substrate 3 may further include a heat releasing section 50 made of a material with relatively high thermal conductivity on a rear surface (surface, of the substrate 70, on side opposite to the phosphor layer 60) of the substrate 70. The heat releasing section 50 is configured by, for example, a plurality of fins extending in a predetermined direction. The fins are each made of, for example, light-weight metal with relatively high thermal conductivity such as aluminum.

FIG. 17 illustrates a cross-sectional configuration example of each of the phosphor substrate 3 and a base section 91, with the base section 91 being attached to the phosphor substrate 3. It is to be noted that FIG. 17 exemplifies a state where the base section 91 is attached to the phosphor substrate 3 illustrated in FIG. 13.

The base section 91 is so fixed to the substrate 70 as to avoid a part, of the substrate 70, immediately below the phosphor layer 60. An upper part of the base section 91 has a disc shape, for example, and has a recessed part 91A at the center of the disc as well as a plurality of openings 91B, on the outer edge of the disc, through which respective screws 92 are inserted. The substrate 70 has openings 71 at locations corresponding to the respective openings 91B when the base section 91 is attached to the substrate 70. The insertion of the screws 92 into the respective openings 91B and the respective openings 71 allows the base section 91 to be fixed to the substrate 70.

[Light Source Device 4]

Description is given next of a light source device 4 including the above-described phosphor substrate 3. FIG. 18 illustrates a schematic configuration example of the light source device 4 using the above-described phosphor substrate 3. The light source device 4 is a light source device in which the above-described phosphor substrate 3 is applied to the light converting section 4A. Specifically, the light source device 4 includes the light converting section 4A and the light source section 2B. The light source section 2B serves to irradiate the light converting section 4A with the excitation light L1. The light source section 2B corresponds to a specific example of a “light source” of the present technology.

The light converting section 4A serves to output, to the light source section 2B, the fluorescence L2 having a peak of emission intensity within a wavelength range different from the wavelength range of the excitation light L 1. The light converting section 4A outputs the fluorescence L2 to the light source section 2B, with the light emitted from the light source section 2B as the excitation light L1. The light converting section 4A includes the phosphor substrate 3 instead of the phosphor substrate 1 in the light converting section 2A. The light converting section 4A further includes the base section 91 instead of the attachment 42 and the motor 121 in the light converting section 2A.

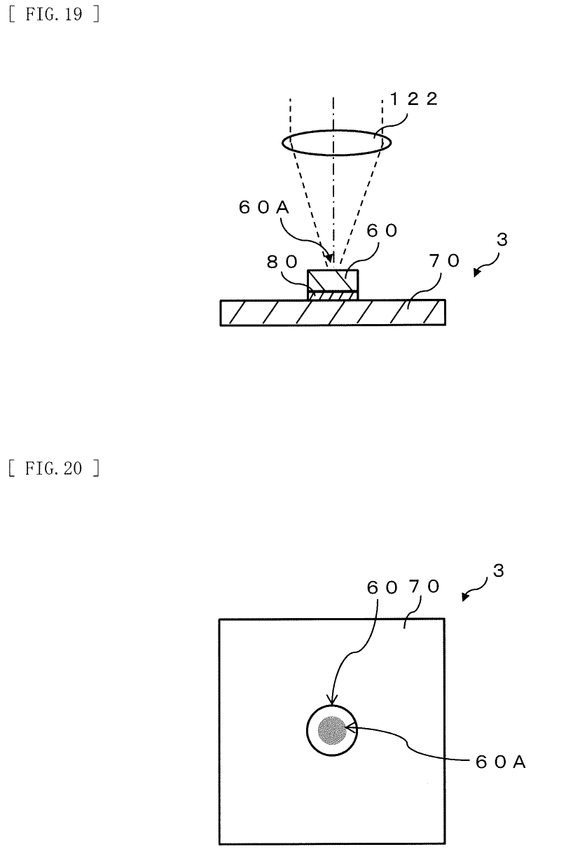

FIGS. 19 and 20 illustrate an example of irradiation of the phosphor substrate 3 with the excitation light L1, in the light source device 4. The light condensing lens 122 is configured to cause the excitation light L1 after having been condensed by the condensing lens 122 to irradiate the center of the top surface of the phosphor layer 60. Here, the phosphor layer 60 does not rotate constantly, and thus a part, of the phosphor layer 10, to be irradiated by the excitation light L1 is a center part of the top surface of the phosphor layer 60. The part, of the phosphor layer 10, to be irradiated by the excitation light L1 is denoted as a light-irradiated point 60A. When the phosphor layer 60 is irradiated by the excitation light L1, the phosphor layer 60 rotates around the rotational axis AX1 together with the substrate 70. Accordingly, the excitation light L1 irradiates the outer edge of the top surface of the phosphor layer 60 annularly during the rotation of the phosphor layer 60. Thus, the light-irradiated point 60A moves along the outer edge of the top surface of the phosphor layer 60 during the rotation of the phosphor layer 60. It is to be noted that the light-irradiated region 60B of FIG. 17 corresponds to an annular region along which the light-irradiated point 60A passes on the top surface of the phosphor layer 60.

Now suppose that an energy distribution of the excitation light L1 is Gaussian distribution. In this case, the excitation light L1 has a beam diameter that corresponds to a diameter of a light flux having an intensity equal to or larger than 1/e² (=13.5%) of center intensity. Suppose below that the light-irradiated point 60A has a diameter that is equal to the beam diameter of the excitation light L1. Here, 99.9% or more of the total energy of the excitation light L1 is within a light flux with a diameter that is 1.52 times as large as the beam diameter of the excitation light L1. Therefore, the phosphor layer 60 preferably has the diameter that is 1.52 times as large as the beam diameter of the excitation light L1 (the diameter of the light-irradiated point 60A). Suppose that the beam diameter of the excitation light L1 (the diameter of the light-irradiated point 60A) is 3 mm from the viewpoint of the light conversion efficiency. At this time, the phosphor layer 60 preferably has a diameter equal to or more than 4.56 mm (=3 mm×1.52).

### [Effects]

Description is given next of effects of the phosphor substrate 3 and the light source device 4 according to the present embodiment.

In the present embodiment, the phosphor layer 60 is disposed at the center of the substrate 70. This enables a displacement amount of the phosphor layer 60 to be smaller than a case where the phosphor layer is disposed on the outer edge of the substrate or on the entire substrate even when warpage occurs in the substrate 70 due to stress caused by respective thermal expansions of the phosphor layer 60 and the substrate 70. As a result, it is possible to reduce the deviation of the focal position caused by the thermal expansions.

Further, in the present embodiment, in a case where the substrate 70 and the binder contained in the phosphor layer 60 are each made of the same type of material, when warpage occurs in the substrate 70 due to stress caused by the respective thermal expansions of the phosphor layer 60 and the substrate 70, it is possible to allow the displacement amount of the phosphor layer 60 to be smaller than a situation when the substrate and the binder contained in the phosphor layer are made of different types of materials. As a result, it is possible to reduce the deviation of the focal position caused by the thermal expansions. Moreover, it is possible to allow the displacement amount of the phosphor layer 60 to be smaller, thus making it possible to reduce a possibility that the phosphor layer 60 may be damaged even in a case where the phosphor layer 60 is configured to be thin and is likely to be damaged.

Furthermore, in the present embodiment, in a case where the substrate 70 and the phosphor layer 60 are made of respective materials that allow the substrate 70 and the phosphor layer 60 to have a difference in linear expansion coefficients of 1×10⁻⁶ cm/° C. or smaller, it is possible to allow the displacement amount of the phosphor layer 60 to be smaller than a case where the substrate and the phosphor layer are made of respective materials that allow the substrate and the phosphor layer to have a difference exceeding 1×10⁻⁶ cm/° C. in linear expansion coefficients. As a result, it is possible to reduce the deviation of the focal position caused by the thermal expansions. Moreover, it is possible to allow the displacement amount of the phosphor layer 60 to be smaller, thus making it possible to reduce the possibility that the phosphor layer 60 may be damaged even in the case where the phosphor layer 60 is configured to be thin and is likely to be damaged.

### 3. Third Embodiment

### [Configuration]

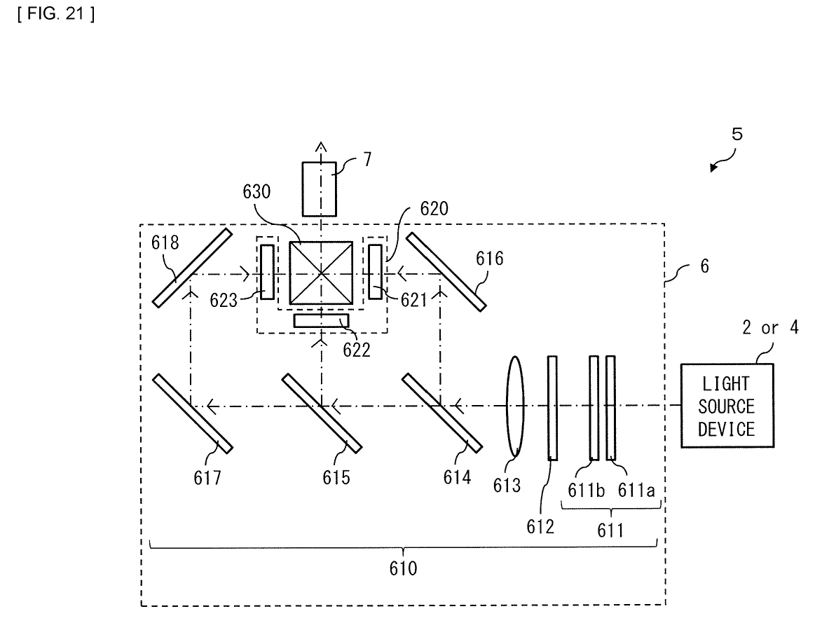

Description is given next of a projector 5 according to a third embodiment of the present technology. The projector 5 corresponds to a specific example of a “projection display unit” of the present technology. FIG. 21 illustrates a schematic configuration example of the projector 5 according to the third embodiment of the present technology. The projector 5 includes one of the above-described light source device 2 and the above-described light source device 4. The projector 5 further includes an image generating system 6 and a projection optical system 7.

The image generating system 6 modifies, on the basis of an image signal, the light (white light Lw) emitted from one of the above-described light source device 2 and the above-described light source device 4 to generate pieces of image light of a plurality of colors, and synthesizes the generated pieces of image light of the plurality of colors to output the synthesized pieces of image light of the plurality of colors to the projection optical system 7. The image generating system 6 includes an illumination optical system 610, an image generating section 620, and an image synthesizing section 630. The projection optical system 7 projects the image light (synthesized image light) outputted from the image generating system 6 onto a screen, for example. The image generating system 6 corresponds to a specific example of a “light modulating section” of the present technology. The projection optical system 7 corresponds to a specific example of a “projecting section” of the present technology.

The illumination optical system 610 splits the light (white light Lw) emitted from one of the above-described light source device 2 and the above-described light source device 4 into pieces of color light. The illumination optical system 610 includes, for example, an integrator element 611, a polarization conversion element 612, a condensing lens 613, dichroic mirrors 614 and 615, and mirrors 616 to 618. The integrator element 611 includes a fly's eye lens 611a and a fly's eye lens 611b, for example. The fly's eye lens 611a includes a plurality of microlenses disposed two-dimensionally. The fly's eye lens 611b also includes the plurality of microlenses disposed two-dimensionally. The fly's eye lens 611a splits the light (white light Lw) emitted from one of the above-described light source device 2 and the above-described light source device 4 into a plurality of light fluxes, and forms images on respective microlenses of the fly's eye lens 611b. The fly's eye lens 611b functions as a secondary light source, and causes pieces of parallel light having coincident luminance to enter the polarization conversion element 612. The dichroic mirrors 614 and 615 each selectively reflect color light of a predetermined wavelength, and transmits light of any other wavelength. The dichroic mirror 614 selectively reflects red light, for example. The dichroic mirror 615 selectively reflects green light, for example.

The image generating section 620 modifies each piece of color light split by the illumination optical system 610 on the basis of an image signal, inputted from the outside, that corresponds to each color, and generates pieces of image light of the respective colors. The image generating section 620 includes, for example, a red light valve 621, a green light valve 622, and a blue light valve 623. The red light valve 621 modifies red light inputted from the illumination optical system 610 on the basis of an image signal, inputted from the outside, that corresponds to a red color, and generates red image light. The green light valve 622 modifies green light inputted from the illumination optical system 610 on the basis of an image signal, inputted from the outside, that corresponds to a green color, and generates green image light. The blue light valve 623 modifies blue light inputted from the illumination optical system 610 on the basis of an image signal, inputted from the outside, that corresponds to a blue color, and generates blue image light.

The image synthesizing section 630 synthesizes the pieces of image light of the respective colors generated in the image generating section 620, and generates color image light.

### [Effects]

Description is given next of effects of the projector 5 of the present embodiment.

In the present embodiment, one of the above-described light source device 2 and the above-described light source device 4 is used as a light source. This makes it possible to reduce the deviation of the focal position caused by the thermal expansions in one of the above-described light source device 2 and the above-described light source device 4, thus preventing luminance of the color image light outputted from the projector 5 from being lower than a desired value.

Although description has been given heretofore by referring to the three embodiments, the present technology is not limited thereto and may be modified in a variety of ways. It is to be noted that effects described herein are mere examples. Effects of the present technology are not limited to the effects described herein. Effects of the present technology may include other effects than the effects described herein.

For example, although description has been given, in the foregoing embodiment, of the example in which the present technology is applied to the light source device of the projector 5, it is also possible as a matter of course to apply the present technology to an illumination unit, for example. Examples of the illumination unit include a headlight of a vehicle, for example.

Moreover, for example, the present technology may have the following configurations.
(1)

A phosphor substrate including:

a substrate configured to be rotatable; and

a phosphor layer disposed at a center of the substrate.
(2)

The phosphor substrate according to (1), in which

the substrate and the phosphor layer each have a disc shape, and

the phosphor layer is disposed concentrically with the substrate.
(3)

The phosphor substrate according to (1), in which

the substrate has a disc shape, and

the phosphor layer has an annular shape and is disposed concentrically with the

substrate.
(4)

The phosphor substrate according to any one of (1) to (3), in which the phosphor layer includes a phosphor and a binder that holds the phosphor.
(5)

The phosphor substrate according to (4), in which the substrate and the binder are each made of a same type of material.
(6)

The phosphor substrate according to (5), in which the substrate and the binder each contain a ceramic material.
(7)

The phosphor substrate according to (6), in which the substrate and the phosphor layer are each formed by sintering a plurality of layers each containing the ceramic material in a state of being joined together.
(8)

The phosphor substrate according to any one of (1) to (7), in which

the substrate has a recessed part at the center, and

the phosphor layer is disposed inside the recessed part.
(9)

The phosphor substrate according to (3), in which the substrate and the phosphor layer are made of respective materials that allow the substrate and the phosphor layer to have a difference in linear expansion coefficients of 1×10⁻⁶ cm/° C. or smaller.
(10)

The phosphor substrate according to (9), in which

the substrate is made of a titanium alloy, and

the phosphor layer includes a polycrystalline plate made of a ceramic material.
(11)

A phosphor substrate including:

a substrate; and

a phosphor layer disposed at a center of the substrate, in which

the phosphor layer includes a phosphor and a binder that holds the phosphor, and

the substrate and the binder are each made of a same type of material.
(12)

The phosphor substrate according to (11), in which the substrate and the binder each contain a ceramic material.
(13)

The phosphor substrate according to (12), in which the substrate and the phosphor layer are each formed by sintering a plurality of layers each containing the ceramic material in a state of being joined together.
(14)

A phosphor substrate including:

a substrate; and

a phosphor layer disposed at a center of the substrate, in which the substrate and the phosphor layer are made of respective materials that allow the substrate and the phosphor layer to have a difference in linear expansion coefficients of 1×10⁻⁶ cm/° C. or smaller.
(15)

The phosphor substrate according to (14), in which

the substrate is made of a titanium alloy, and

the phosphor layer includes a polycrystalline plate made of a ceramic material.
(16)

A light source device including:

a substrate configured to be rotatable;

a phosphor layer disposed at a center of the substrate; and

a light source that irradiates the phosphor layer with excitation light.
(17)

The light source device according to (16), in which

the phosphor layer includes a phosphor and a binder that holds the phosphor, and

the substrate and the binder are each made of a same type of material.
(18)

The light source device according to (16), in which the substrate and the phosphor layer are made of respective materials that allow the substrate and the phosphor layer to have a difference in linear expansion coefficients of 1×10⁻⁶ cm/° C. or smaller.
(19)

A light source device including:

a substrate;

a phosphor layer disposed at a center of the substrate; and

a light source that irradiates the phosphor layer with excitation light, in which

the phosphor layer includes a phosphor and a binder that holds the phosphor, and

the substrate and the binder are each made of a same type of material.
(20)

A light source device including:

a substrate;

a phosphor layer disposed at a center of the substrate; and

a light source that irradiates the phosphor layer with excitation light, in which the substrate and the phosphor layer are made of respective materials that allow the substrate and the phosphor layer to have a difference in linear expansion coefficients of 1×10⁻⁶ cm/° C. or smaller.
(21)

A projection display unit including:

a substrate configured to be rotatable;

a phosphor layer disposed at a center of the substrate;

a light source that irradiates the phosphor layer with excitation light;

a light modulating section that generates image light by modulating the excitation light emitted from the light source on a basis of an image signal; and

a projecting section that projects the image light generated in the light modulating section.
(22)

The projection display unit according to (21), in which

the phosphor layer includes a phosphor and a binder that holds the phosphor, and

the substrate and the binder are each made of a same type of material.
(23)

The projection display unit according to (21), in which the substrate and the phosphor layer are made of respective materials that allow the substrate and the phosphor layer to have a difference in linear expansion coefficients of 1×10⁻⁶ cm/° C. or smaller.
(24)

A projection display unit including:

a substrate;

a phosphor layer disposed at a center of the substrate;

a light source that irradiates the phosphor layer with excitation light;

a light modulating section that generates image light by modulating the excitation light emitted from the light source on a basis of an image signal; and

a projecting section that projects the image light generated in the light modulating section, in which the phosphor layer includes a phosphor and a binder that holds the phosphor, and

the substrate and the binder are each made of a same type of material.
(25)

A projection display unit including:

a substrate;

a phosphor layer disposed at a center of the substrate;

a light source that irradiates the phosphor layer with excitation light;

a light modulating section that generates image light by modulating the excitation light emitted from the light source on a basis of an image signal; and

a projecting section that projects the image light generated in the light modulating section, in which the substrate and the phosphor layer are made of respective materials that allow the substrate and the phosphor layer to have a difference in linear expansion coefficients of 1×10⁻⁶ cm/° C. or smaller.

This application is based upon and claims priority from Japanese Patent Application No. 2015-099209 filed with the Japan Patent Office on May 14, 2015, the entire contents of which are hereby incorporated by reference.

It should be understood by those skilled in the art that various modifications, combinations, sub-combinations, and alterations may occur depending on design requirements and other factors insofar as they are within the scope of the appended claims or the equivalents thereof.

1. A phosphor substrate comprising:
a substrate configured to be rotatable; and
a phosphor layer disposed at a center of the substrate.

2. The phosphor substrate according to claim 1, wherein
the substrate and the phosphor layer each have a disc shape, and
the phosphor layer is disposed concentrically with the substrate.

3. The phosphor substrate according to claim 1, wherein
the substrate has a disc shape, and
the phosphor layer has an annular shape and is disposed concentrically with the substrate.

4. The phosphor substrate according to claim 1, wherein the phosphor layer includes a phosphor and a binder that holds the phosphor.

5. The phosphor substrate according to claim 4, wherein the substrate and the binder are each made of a same type of material.

6. The phosphor substrate according to claim 5, wherein the substrate and the binder each contain a ceramic material.

7. The phosphor substrate according to claim 6, wherein the substrate and the phosphor layer are each formed by sintering a plurality of layers each containing the ceramic material in a state of being joined together.

8. The phosphor substrate according to claim 7, wherein
the substrate has a recessed part at the center, and
the phosphor layer is disposed inside the recessed part.

9. The phosphor substrate according to claim 3, wherein the substrate and the phosphor layer are made of respective materials that allow the substrate and the phosphor layer to have a difference in linear expansion coefficients of 1×10⁻⁶ cm/° C. or smaller.

10. The phosphor substrate according to claim 9, wherein
the substrate is made of a titanium alloy, and
the phosphor layer comprises a polycrystalline plate made of a ceramic material.

11. A light source device comprising:
a substrate configured to be rotatable;
a phosphor layer disposed at a center of the substrate; and
a light source that irradiates the phosphor layer with excitation light.

12. The light source device according to claim 11, wherein
the phosphor layer includes a phosphor and a binder that holds the phosphor, and
the substrate and the binder are each made of a same type of material.

13. The light source device according to claim 11, wherein the substrate and the phosphor layer are made of respective materials that allow the substrate and the phosphor layer to have a difference in linear expansion coefficients of 1×10⁻⁶ cm/° C. or smaller.

14. A light source device comprising:
a substrate;
a phosphor layer disposed at a center of the substrate; and
a light source that irradiates the phosphor layer with excitation light, wherein
the phosphor layer includes a phosphor and a binder that holds the phosphor, and
the substrate and the binder are each made of a same type of material.

15. A light source device comprising:
a substrate;
a phosphor layer disposed at a center of the substrate; and
a light source that irradiates the phosphor layer with excitation light, wherein the substrate and the phosphor layer are made of respective materials that allow the substrate and the phosphor layer to have a difference in linear expansion coefficients of 1×10⁻⁶ cm/° C. or smaller.

16. A projection display unit comprising:
a substrate configured to be rotatable;
a phosphor layer disposed at a center of the substrate;
a light source that irradiates the phosphor layer with excitation light;
a light modulating section that generates image light by modulating the excitation light emitted from the light source on a basis of an image signal; and
a projecting section that projects the image light generated in the light modulating section.

17. The projection display unit according to claim 16, wherein
the phosphor layer includes a phosphor and a binder that holds the phosphor, and
the substrate and the binder are each made of a same type of material.

18. The projection display unit according to claim 16, wherein the substrate and the phosphor layer are made of respective materials that allow the substrate and the phosphor layer to have a difference in linear expansion coefficients of 1×10⁻⁶ cm/° C. or smaller.

19. A projection display unit comprising:
a substrate;
a phosphor layer disposed at a center of the substrate;
a light source that irradiates the phosphor layer with excitation light;
a light modulating section that generates image light by modulating the excitation light emitted from the light source on a basis of an image signal; and
a projecting section that projects the image light generated in the light modulating section, wherein
the phosphor layer includes a phosphor and a binder that holds the phosphor, and
the substrate and the binder are each made of a same type of material.

20. A projection display unit comprising:
a substrate;
a phosphor layer disposed at a center of the substrate;
a light source that irradiates the phosphor layer with excitation light;
a light modulating section that generates image light by modulating the excitation light emitted from the light source on a basis of an image signal; and
a projecting section that projects the image light generated in the light modulating section, wherein the substrate and the phosphor layer are made of respective materials that allow the substrate and the phosphor layer to have a difference in linear expansion coefficients of 1×10⁻⁶ cm/° C. or smaller.
